(19) United States
(12) Patent Application Publication
(10) Pub. No.: US 2025/0023292 A1
(43) Pub. Date: Jan. 16, 2025

(54) Connector with contact insert attachment

(71) Applicant: HARTING Electric Stiftung & Co. KG, Espelkamp (DE)

(72) Inventor: Albert FERDERER, Espelkamp (DE)

(73) Assignee: HARTING Electric Stiftung & Co. KG, Espelkamp (DE)

(21) Appl. No.: 18/769,422

(22) Filed: Jul. 11, 2024

(30) Foreign Application Priority Data
Jul. 13, 2023 (DE) 10 2023 118 585.3

(51) Int. Cl. H01R 13/621; H01R 13/518; H01R 13/639

(52) U.S. Cl. CPC H01R 13/621; H01R 13/518; H01R 13/639

(57) ABSTRACT

An electrical connector has a connector housing with a cable feedthrough opening, a connection opening, at least one first retention feature and at least one contact insert. The contact insert accommodates at least one contact element and/or at least one connector module and/or a half connector module. The contact insert has at least one fastening frame that has at least one second retention feature. The second retention feature corresponds to the first retention feature. The corresponding retention feature, the first retention feature and the second retention feature, are detachably connected by a fastener, The fastening frame is held in the connector housing by the fastener. The fastener has at least one fixing body, a spring element, and a fixing element.

### CROSS-REFERENCE TO RELATED APPLICATION

This application claims the benefit of German Patent Application DE 10 2023 118 585.3, filed on Jul. 13, 2023, which is incorporated by reference in its entirety.

### BACKGROUND

The present application relates to an electrical plug-in connector with a contact insert attachment. The application further relates to a method for connecting a contact insert to a connector housing of a connector.

Contact insert attachments are required to fasten a contact insert, which may for example be designed as a module holding frame for accommodating connector modules and/or half connector modules, in a connector housing, preferably detachably.

Industrial connectors, also known as heavy-duty connectors or rectangular connectors, usually have a contact insert which is releasably attached to the connector housing by means of screw connections. The contact insert can be designed to directly receive contact elements. Alternatively, the state of the art also offers solutions in which a contact insert is designed as a holding frame, which in turn accommodates one or more identical and/or different connector modules. Connector modules can consist of several modular components, which can be of the same or different design.

U.S. Pat. No. 6,004,162 discloses a connector with a contact carrier, wherein the contact carrier is designed as a holding frame for connector modules. The contact carrier is usually fastened in the connector housing using screw connections. U.S. Pat. No. 6,004,162 is incorporated by reference in its entirety.

A disadvantage of the connection technology primarily used in the prior art is the comparatively long time required to detachably insert a contact carrier into a connector housing by means of the usually four screw connections provided at the corners of the contact carrier.

### SUMMARY

The present disclosure provides a connector which can be equipped with a contact insert in a simple and quick manner. The contact insert is detachably and firmly fastened in a connector housing of the connector.

Furthermore, the disclosure provides a method for the simple and rapid fastening of a contact insert in a connector housing, which method engages the contact insert detachably and with a firm fit in the connector housing.

An electrical connector has a connector housing with a cable feedthrough opening, a connection opening, at least one first retention feature and at least one contact insert. The contact insert accommodates at least one contact element and/or at least one connector module and/or a half connector module. The contact insert has at least one fastening frame that has at least one second retention feature. The second retention feature corresponds to the first retention feature. In particular, the second retention feature is coaxially aligned with the first retention feature. The corresponding retention feature, the first retention feature and the second retention feature, are detachably connected by a fastener. The fastening frame is held in the connector housing by the fastener. The fastener has at least one fixing body, a spring element, and a fixing element.

Connector housings are generally understood to be housings of cable ends provided with contact elements. Connector housings are usually made of metal or plastic. In the case of a plastic housing, electrically conductive plastics may be used. There are also connector housings that are formed from composite materials, wherein the housings can be formed from metal and plastic or various metals or various plastics.

Cable feedthrough openings are particularly apertures in the connector housing through which one or more electrical wires and/or cables can pass through into the connector. These cable feedthrough openings are usually sealed by cable glands so that the cables passed through the openings are at least partially sealed against foreign media such as dust, dirt, or fluids.

The term connection opening refers to an aperture in the connector housing which is designed for connection to a mating connector, or the mating connector housing and/or the contact elements arranged therein.

The term first retention feature refers to a device on or within the connector housing which is designed to enable the attachment of further components of the connector. Usually, blind holes with internal threads are used in connector housings, into which a screw is inserted to attach additional components. The first retention feature usually protrudes into the connector housing, whereby further components are secured towards the interior of the connector housing. The first retention feature may in particular be a blind hole, a cavity, a slot or an indentation, generally forming a hollow receptacle.

The term contact insert encompasses various designs. For example, contact inserts can be simple insulating bodies and/or contact carriers which are used to accommodate and/or spatially and/or electrically separate contact elements. Populated module holding frames, i.e. holding frames with modules accommodated therein, are also understood as contact inserts. Such module holding frames are designed to accommodate different and/or similar connector modules, whereby each connector module is understood as a contact insert or contact carrier. Recently, there have also been a large number of connector modules which can be formed from identical and/or different sub-modules.

On the one hand, fastening frames are molded and/or mounted frames which are designed to fasten a contact insert in a connector housing. A module holding frame also usually has the characteristics of a fastening frame. Particularly in the case of simple insulating bodies, fastening frames can be designed in several parts and arranged on the insulating body.

The term second retention feature refers to a device on or within the fastening frame which is designed to enable the attachment of a contact carrier to the connector housing. Typically, through holes are used in fastening frames through which a screw is passed for fastening to the connector housing. The second retention feature usually protrudes outwards, i.e. away from the contact carrier. The second retention feature may be an aperture, for example a through hole.

The fastener refers to an element which is provided for connecting the first retention feature to the second retention feature. The fastener is used to secure a contact insert in a connector housing. Ideally, the fastener is designed to releasably connect the contact insert to the connector housing. The fastener is composed of several components. These components include at least one fixing body, a spring element, and a fixing element. For different embodiments, the named components can consist of several elements. The fixing body may comprise at least two elements, for example a turned pin and a head and/or flange arranged on it. In a particularly advantageous manner, the spring element can be embodied as at least one disc spring and/or a spiral spring and/or a leaf spring and/or a wave spring and/or a rubber spring. Combinations of the aforementioned and other spring elements are conceivable.

The fastening element designed in this way enables simple, quick and reliable installation of the contact insert in the connector housing. It is particularly useful to design the fixing body as a pin-shaped element with a head and/or flange, which covers the second retention feature of the fastening frame. In this way, the retention feature and, associated therewith, the contact insert cannot pass over the fastening element, so that the secure connection is guaranteed.

One embodiment provides that the fastener is designed as a rivet, in particular as an expanding rivet. The terms can be assigned as follows: The fixing body is formed by the rivet head. The expansion legs, or at least their connection to the rivet head, represent the spring element. The rivet pin is considered to be the fixing element. In order to design the expanding rivet to be detachable, it is proposed to design the rivet pin with a head, which makes it possible to remove the pin from the actuated expanding rivet.

Alternatively, the fastener is designed as a quick-release fastener, in particular as a quarter-turn fastener. In this case, the locking pin with locking bolts represents the fixing body. The normally used disc spring and/or spiral springs can be recognized as a spring element. A sleeve with a curved track and/or a curved track arranged on the first retention feature is to be understood as a fixing element. Alternatively, a simple recess can be provided for the curved track, which corresponds to the locking bolt. Other designs of a quarter-turn fastener can also be considered.

In a further developed embodiment, the fastener has a release element. Components are provided as the release element, which are designed to return the fastener to an initial state in a simple manner, so that both the fastener and the contact inserts fastened in this way can be removed again from the connector housing. An essentially sleeve-shaped design of the release element is particularly clever. The sleeve can be designed as a tubular C-clip. In other words, a release element can have a slot, which, particularly in combination with integrally designed fixing bodies, makes it possible to connect the two components to one another in a simple manner.

A further embodiment provides that the release element is connected to at least one flag which, after actuation of the fastener, points and/or protrudes from the fixing body, whereby the engagement of the fastener in the fastening device is signaled. Such a signaling can further simplify assembly, which advantageously indicates the secure actuation of the fastener, particularly in the case of a quarter-turn fastener and/or push-push locking.

A further embodiment provides that the fixing element is brought into engagement with the first retention feature of the connector housing. This means that a locking sleeve of a push-push mechanism is screwed, pressed or glued into the first retention feature. Instead of a locking sleeve, a locking spring, a locking hook or a comparable element can be inserted in a similar way. Alternatively, in the case of a quarter-turn fastener, a fitting for the locking bolt of the locking pin can be incorporated into the first retention feature, or introduced by a component such as a sleeve. Such a sleeve can be screwed, pressed or glued, similar to a fixing element of a push-push mechanism.

A further embodiment provides that the fastener is brought into releasable engagement with the fixing element by a first pressure movement of the fixing body in the direction of the connector housing of the fixing body. For this purpose, the fixing body is provided, for example, with a recess into which a fixing element at least partially engages during the first pressure movement. In certain embodiments, for example in the case of pin-like fixing bodies, it can be useful to form the depression circumferentially, so that a fixing element surrounding the fixing body in form of a tube also engages into the depression without any problems. Locking mechanisms such as push-in mechanisms, push-pull mechanisms and/or push-push mechanisms can therefore be provided.

A further embodiment provides that the fixing body is released from the fixing element by a second pressure movement of the fixing body towards the connector housing. Such locking mechanisms are known from ballpoint pens, for example, and are called ballpoint pen mechanisms or push-push mechanisms. For this purpose, the fixing body is preferably provided with a release element, wherein the release element is arranged as a sleeve within a circumferential recess so as to be displaceable along the longitudinal axis of the fixing body. The fixing element is designed as a sleeve which tapers conically against the plugging direction, at least in its end area. At least the tapering part of the fixing element is provided with longitudinally directed recesses, which allows elastic deformation. The first pressure movement of the fixing body displaces the release element from the fixing element. The fixing element then engages in the recess of the fixing body. The spring element presses the fixing body in the plugging direction. However, since the fixing element engages in the recess of the fixing body, the contact insert and the connector housing remain connected by the force of the spring tension of the spring element.

A further embodiment provides that the fastener is brought into releasable engagement with the fixing element along the longitudinal axis of the fixing body by a first rotational movement. In this case, rotational movement refers to at least a partial rotation but at most a full rotation of the fixing body. In this way, a distinction is made from regular screw connections, which usually require several threads, i.e. full turns.

A further embodiment provides that the fastener, in particular the fixing body, is additionally subjected to a first pressure movement. This pressure movement is particularly required for known quarter-turn closures in order to bring the locking bolt of the fixing body into engagement with the curved track of the fixing element. The fastener is essentially released from the fixing element by a second rotational movement along the longitudinal axis of the fixing body. The second rotational movement is carried out against the direction of rotation of the first rotational movement.

Furthermore, the invention discloses a method for connecting a contact insert to a connector housing of a connector. The connector housing has at least a first retention feature and the contact insert has at least a second retention feature. The first retention feature corresponds to the second retention feature. At least one fastener is used to connect the contact insert to the connector housing. The fastener has a fixing body, a fixing element and a spring element.

In a further embodiment, the fastener engages, by a first pressure movement on the fixing body in the direction of the connector housing, in a fixing element which is in engagement with the first retention feature, the contact insert being secured against accidental release in the plug-in direction and being secured against accidental release from the first retention feature counter to the plug-in direction by the fastener.

A further embodiment provides that a second pressure movement on the fixing body opposite to the plugging direction releases the fastener from the first retention feature in such a way that the fixing body can be removed from the first retention feature.

A further embodiment provides that the fastener engages, by a first rotational movement along the longitudinal axis of the fixing body, in a fixing element which is in engagement with the first retention feature, and that the contact insert is secured against accidental release in the plug-in direction by means of the fastener and is secured against accidental release from the first retention feature counter to the plug-in direction.

### BRIEF DESCRIPTION OF THE DRAWINGS

FIG. 1 is a perspective sectional view of a fastener in a connector;

FIG. 2 is a rotated perspective sectional view of a fastener in a connector;

FIG. 3 is a perspective sectional view of an alternative fastener in a connector;

FIG. 4 is a perspective view of a fastener in a fastening frame.

### DETAILED DESCRIPTION

The figures contain partially simplified, schematic illustrations. In some cases, identical reference numerals are used for alike, but possibly not identical elements. Different views of the same elements could be scaled differently. Directional indications such as “left,” “right,” “top,” and “bottom” are to be understood with reference to the respective figure and do not indicate any particular orientation of parts when in use.

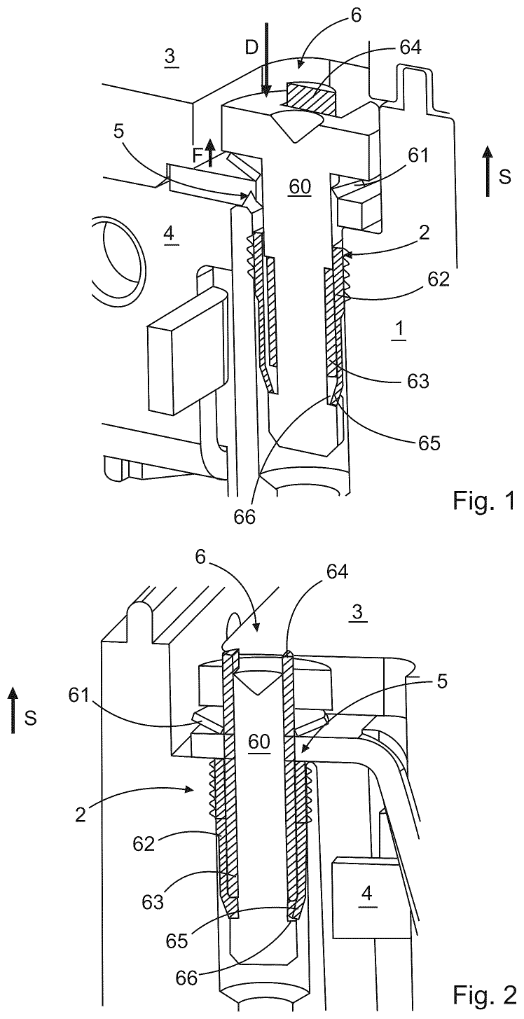

FIGS. 1 and 2 show a section of an electrical connector. A part of the connector housing 1 can be seen. The connector housing 1 has a blind hole, which is provided with an internal thread and forms the first retention feature 2. Furthermore, a part of a contact carrier 3 can be seen, which is designed to accommodate electrical contact elements (not shown). The contact carrier 3 is made of a plastic. The contact carrier 3 is enclosed by a fastening frame 4. The fastening frame 4 can be designed in one piece. Alternatively, the fastening frame 4 is formed from two or more individual elements. The fastening frame 4 has a second retention feature 5, which in the illustrations is designed as a simple through opening. A fastener 6 is guided through the second retention feature 5 and engages in the first retention feature 2. The fastener 6 is designed in several parts. A fixing body 60 is designed with a cylindrical head 67, which has a larger diameter at its widest point than the diameter of the second retention feature 5. The fastener 6 also has a spring element 62, which is shown in FIG. 1 as a disc spring. Two or more disc springs can be used to improve the retaining effect. The outer diameter of the spring element is comparable to the diameter of the head 67. Furthermore, a fixing element 62 belongs to the fastener 6, wherein the fixing element 62 is arranged in the first retention feature 2. The fixing element 62 is screwed into the first retention feature 2 in a simple manner. Alternative fastenings of the fixing element 62 in the first retention feature 2 are conceivable and can offer advantages. In this case, methods such as pressing in or gluing in can be provided in particular. The fixing element 62 of the fastener 6 has a locking element 65 pointing opposite to the plug-in direction S. The locking element 65 is designed to interact with a locking feature 66 of the fixing body 60. In a clever way, the fixing body 60 further comprises a release element 63. The fastener 6 is thus moved opposite to the plug-in direction S during a first-time pressure movement D, wherein the fixing element 62 initially retains the release element 63. While the release element 63 is being held back, the locking element 65 of the fixing element 62 can engage in the locking feature 66 of the fixing body 60. Forced by the spring force F in the plugging direction S, the fastening frame 4 is fixed in the connector housing 1. A second, deeper pressure movement D moves the release element 63 along the fixing element 62 against the plugging direction S, so that the locking element 65 is released from the locking feature 66. The locking element 65 can temporarily fix the release element 63 so that the locking element 65 cannot engage the locking feature 66 again when the fixing body 60 is retracted. As a result, the fastener 6 is released, so that the fastening frame 4 can be removed from the connector housing 1. Instead of a second pressure movement D for releasing the fastener 6, the release element 63 has a flag 64 which remains in position after the first pressure movement D in such a way that an engagement of the locking element 65 in the locking feature 66 is indicated. This flag 64 can ideally be used to move the release element 63 against the plugging direction S in order to initiate the release process of the locking element 65 from the locking feature 66.

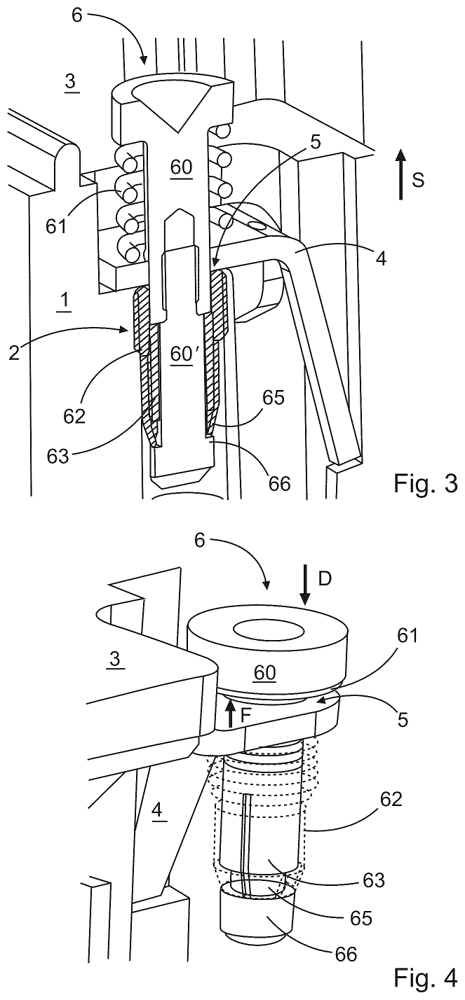

FIG. 3 shows an alternative embodiment. It is shown particularly clearly that the fixing body 60 is designed in two parts, namely a first fixing body 60 and a second fixing body 60′. This embodiment makes it possible in particular to design the release element 63 as a tubular sleeve, while the one-piece embodiment of FIGS. 1, 2 and 4 requires that the release element 63 can be clipped/slid onto the fixing body 60. In FIG. 3, the fixing body components, first fixing body 60 and second fixing body 60′, are shown screwed together. Other fastening and/or joining methods are conceivable and may be useful. Furthermore, in the embodiment shown, no flag is assigned to the release element 63. In order to achieve sufficient fastening of the first retention feature 2 and the second retention feature 5, the spring element 61 is designed as a spiral spring element.

FIG. 4 clearly shows the design of the fastener 6 without a connector housing 1. Here, the fixing element 62 is only indicated in order to better show the interaction of the fixing body 60 with the release element 63 within the fixing element 62. The release element 63 is, as previously mentioned, designed as a sleeve-shaped clip.

Even though various aspects or features of the invention are shown in combination in the figures, it is clear to those skilled in the art—unless otherwise stated—that the combinations shown and discussed are not the only possible ones. In particular, corresponding units or feature complexes from different embodiments can be exchanged with one another.

### LIST OF REFERENCE SIGNS

1 connector housing
2 first retention feature
3 contact insert
4 fastening frame
5 second retention feature
6 fastener
60 fixing body
61 spring element
62 fixing element
63 release element
64 flag
65 locking element
66 locking feature
67 head
S plug-in direction
D pressing movement
F spring force

What is claimed is:

1. An electrical connector, comprising:
a connector housing (1) with a cable feedthrough opening and a connection opening;
a first retention feature (2); and
a contact insert (3),
wherein the contact insert (3) accommodates at least one contact element and/or at least one connector module and/or a half connector module, and
wherein the contact insert (3) has a fastening frame (4) which has a second retention feature (5),
wherein the second retention feature (5) corresponds to the first retention feature (2),
wherein a fastener (6) interacts with the first retention feature (2) and the second retention feature (5),
wherein the fastening frame (4) is held in the connector housing (1) by the fastener (6), and
wherein the fastener (6) has
a fixing body (60),
a spring element (61), and
a fixing element (62).

2. The electrical connector according to claim 1,
wherein the fastener (6) is an expanding rivet.

3. The electrical connector according to claim 1,
wherein the fastener (6) is a quarter-turn fastener.

4. The electrical connector according to claim 1,
wherein the fastener (6) has a release element (63).

5. The electrical connector according to claim 4,
wherein the release element (63) is connected to a flag (64) which, after actuation of the fastener (6), points away from the fixing body (60), whereby engagement of the fastener (6) in the first retention feature (2) is signaled.

6. The electrical connector according to claim 1,
wherein the fixing element (62) is engaged with the first retention feature (2) of the connector housing (1).

7. The electrical connector according to claim 1,
wherein the fastener (6) is brought into releasable engagement with the fixing element (62) by a first pressure movement (D) of the fixing body (60) towards of the connector housing (1).

8. The electrical connector according to claim 7,
wherein the fixing body (60) is released from the fixing element (62) by a second pressure movement (D) of the fixing body (60) towards the connector housing (1).

9. The electrical connector according to claim 1,
wherein the fastener (6) operates according to a push-push principle.

10. The electrical connector according to claim 1,
wherein the fastener (6) is brought into releasable engagement with the fixing element (62) by a first rotational movement along a longitudinal axis of the fixing body (60).

11. The electrical connector according to claim 10,
wherein the fastener (6) is configured to be subjected to a first pressure movement (D) in addition to the first rotational movement.

12. The electrical connector according to claim 10,
wherein the fastener (6) is released from the fixing element (62) by a second rotational movement along the longitudinal axis of the fixing body (60).

13. A method for connecting a contact insert (3) to a connector housing (1),
wherein the connector housing (1) has at least one first retention feature (2),
wherein the contact insert (3) has at least one second retention feature (5),
wherein the first retention feature (2) corresponds to the second retention feature (5),
wherein a fastener (6) is used to connect the contact insert (3) to the connector housing (1), and
wherein the fastener (6) has a fixing body (60), a fixing element (62), and a spring element (61).

14. The method according to claim 13,
wherein the fastener (6) engages, by a first pressure movement (D) on the fixing body (60) towards the connector housing (1), in the fixing element (62) which is in engagement with the first retention feature (2), and the contact insert (3) is secured against accidental release in a plug-in direction (S) by the fastener (6) and is secured against accidental release from the first retention feature (2) counter to the plug-in direction (S).

15. The method according to claim 13, wherein
a second pressure movement (D) on the fixing body (60) counter to an insertion direction (S) releases the fastener (6) from the first retention feature (2) in such a way that the fixing body (60) can be removed from the first retention feature (2).

16. The method according to claim 13, wherein
the fastener (6) engages, by a first rotational movement along a longitudinal axis of the fixing body (60), in the fixing element (62) which is in engagement with the first retention feature (2), and the contact insert (3) is secured against accidental release in a plug-in direction (S) by the fastener (6) and is secured against accidental release from the first retention feature (2) counter to the plug-in direction (S).
